(19) United States
(12) Patent Application Publication
(10) Pub. No.: US 2023/0075352 A1
(43) Pub. Date: Mar. 9, 2023

(54) METHOD AND APPARATUS FOR METROLOGY-IN-THE-LOOP ROBOT CONTROL

(71) Applicant: THE CURATORS OF THE UNIVERSITY OF MISSOURI, Columbia, MO (US)

(72) Inventors: Mitchell R. WOODSIDE, Rolla, MO (US); Douglas A. BRISTOW, Rolla, MO (US); Robert G. LANDERS, Rolla, MO (US)

(73) Assignee: THE CURATORS OF THE UNIVERSITY OF MISSOURI, Columbia, MO (US)

(21) Appl. No.: 17/797,036

(22) PCT Filed: Feb. 26, 2021
(86) PCT No.: PCT/US2021/019939

§ 371 Date: Aug. 2, 2022

Related U.S. Application Data
(60) Provisional application No. 62/982,166, filed on Feb. 27, 2020.

(51) Int. Cl. B25J 9/16; B25J 13/08; G01B 11/00; G01S 17/66

(52) U.S. Cl. CPC B25J 9/1692; B25J 13/089; B25J 9/1628; G01B 11/002; G01S 17/66; G05B 2219/40623

(57) ABSTRACT

In an industrial robot, an external high-precision metrology tracking system, such as a laser tracker system, is used to directly measure robot kinematic errors and corrections are implemented during processing so that the end effector of the robot may be accurately positioned so that a tool or other object carried by the robot effector can carry out a designated function, such as machining a workpiece or other operation requiring that the effector be accurately positioned with respect to a workpiece.

### RELATED APPLICATIONS

The present application is the US national stage under 35 U.S.C. § 371 of International Application No. PCT/US2021/019939 which was filed on Feb. 26, 2021, and which claims priority to U.S. Provisional Application No. 62/982,166, filed on Feb. 27, 2020, the disclosures of which is herein incorporated by reference in their entirety.

### STATEMENT REGARDING FEDERALLY SPONSORED RESEARCH

Not applicable.

### FIELD

The present disclosure relates to dynamic compensation for errors in the position and orientation of a robot end effector, and more particularly dynamically compensating for errors in the position and orientation of a robot end effector utilizing a kinematic error observer algorithm. Even more specifically, this disclosure relates to using an external high-precision metrology tracking system, such as a laser tracker system, to directly measure robot kinematic errors such that corrections are implemented during processing so that the end effector of the robot may be accurately positioned so that a tool or other object carried by the robot effector can carry out a designated function, such as machining a workpiece or other operation requiring that the effector be accurately positioned with respect to a workpiece.

### BACKGROUND OF THE DISCLOSURE

There is a growing interest in replacing high-precision manufacturing equipment such as CNC drills or mills or the like with industrial robots for some applications. Industrial robots were initially designed to be low cost and highly repeatable for pick-and-place and assembly operations. In their current state, do not exhibit sufficient accuracy to achieve high-precision tolerances. Thus, there is a growing interest to develop both the implementation and theory required to improve the accuracy of industrial robots. Of the many methods researched by those skilled in the art, it has been found that the high accuracy and limited obtrusiveness of external metrology tracking systems makes them a viable solution for improving a robot's accuracy when incorporated in an external feedback controller around the robot's proprietary control system.

There are several known instances where metrology tracking systems (e.g. laser trackers), have been utilized to make robots more accurate for a variety of manufacturing applications, such as milling and drilling. In most instances where this has been successful, the approach involves building a custom robot controller as the foundation, in which the tracker system can be integrated at a low level. Such an approach can be prohibitively expensive, outweighing the added value of using a robotic platform for the intended application of a more accurate robot. In accord with the present disclosure, by correcting the robot's kinematic errors, the existing low bandwidth interfaces on the industrial robot controller can be utilized, thus securing a viable business case. However, to perform external high-precision feedback control over such an interface, appropriate control methodologies that address the interfaces non-deterministic behavior are required. Only then can such a controller sufficiently regulate the kinematic error. The invention described in the present disclosure discusses both the implementation and theory of a control system that addresses these issues and through experimentation is shown to reduce kinematic error, improving the robot's accuracy.

As described in this disclosure, kinematic error is the difference between the location of the robot's end effector measured by the robot controller referred to as the kinematic location, and the actual location measured by the metrology tracking system. The term “location”, as used in this disclosure, means both position and orientation. The kinematic location is computed from the robot's encoder measurements mapped through the robot's forward kinematic model, that latter being an idealized nonlinear set of equations relating the position of the robot's joints to the location of its tool flange in Euclidian space. The tool flange provides a physical interface for attaching the robot's end effector and its spatial relationship to the end effector can be easily identified and applied to the forward kinematic model. Sources of kinematic error can be attributed to discrepancies in the robot's forward kinematic model due to inaccurate link lengths, joint offsets, backlash, etc., and errors from external disturbances that are unobservable by the robot's proprietary controller (e.g., deflection of robot's links due to process forces). When the kinematic location is compared to that of the actual location, provided by the metrology tracking system, these errors can be identified and corrected. As described in this disclosure, the term “end effector” is defined to mean any type of tool or device that attaches to the end of the robot's arm. It is understood that the methodology presented in this disclosure is applicable for any type of end effector that can rigidly attach a metrology tracking system's 6 Degree of Freedom (6 DoF) sensor, the device used to determine the position and orientation of the end effector, to the end of the robot arm, and not only the one that is further described or presented in the disclosed figures.

### SUMMARY OF THE DISCLOSURE

Apparatus for controlling an industrial robot is disclosed. The industrial robot has an immovable base, a plurality of links supported by the base, a movable joint between the base and a most proximate link and between each of the adjacent links. One of the links constitutes a most distal link with respect to the base. An end effector is carried by the most distal link. Each of the joints generates a robot measurement signal corresponding to the kinematic position and orientation of the end effector as the end effector is moved by the robot to a desired position and orientation. The industrial robot has a robot control system for controlling movement of the end effector to its the desired position and orientation. More specifically, the apparatus of this disclosure comprises a metrology tracking system (referred to as a tracker) for determining the actual position and orientation of the end effector as it moves toward its desired position and orientation. The tracker has a sensor carried by the end effector for communicating with the tracker. The tracker generates a tracker measurement signal corresponding to the actual position and orientation of the end effector as the end effector moves toward its desired position and orientation and supplies the tracker measurement signal to a computer. The computer is configured to receive the robot measurement signal corresponding to the kinematic position and orientation of the end effector from the robot control system. The computer is further configured to generate a correction command and to communicate the correction command to the robot control system for correcting the position and orientation of the end effector to better match the actual position and orientation of the end effector as determined by the tracker measurement signal as the end effector moves toward its the desired position and orientation thereby to result in a more accurate positioning and orienting of the end effector when in its desired position and orientation.

Also disclosed is a method of controlling an industrial robot, the latter having an immovable base, a plurality of links supported by the base, a movable joint between the base and a most proximate link and between each of the adjacent links. One of the links constitutes a most distal link with respect to the base. An end effector is carried by the most distal ink. Each of the joints generates a robot measurement signal corresponding to the kinematic position and orientation of the end effector as the end effector is moved by the robot to a desired position and orientation. The industrial robot further has a robot control system for controlling movement of the end effector to the desired position and orientation. The method comprises the steps of utilizing a metrology tracking system (also referred to as a tracker) to determine the actual position and orientation of the end effector as the latter is moved toward its desired position and orientation. Utilizing the tracker to generate a measurement signal that corresponds to the actual position and orientation of the end effector as the latter is moved toward the desired position and orientation. The measurement signal is supplied to a computer. The computer receives a kinematic end effector position and orientation signal from the robot control system, and the computer compares the measurement signal and the kinematic end effector location signal and generates an incremental correction command that is transmitted to the robot control system so that the robot control system corrects the end effector location so as to better agree with the measurement signal.

### BRIEF DESCRIPTION OF THE DRAWINGS

The drawings described herein are for illustration purposes only and are not intended to limit the scope of the present teachings in any way. Corresponding reference numerals indicate corresponding parts throughout the several views of drawings. FIG. 1 is a block diagram illustrating the system and method of this disclosure and depicts signals that are transmitted between subsystems and components used in the Kinematic Error Control System of the present disclosure;

FIG. 2 is an illustration of an industrial robot in a kinematic robot pose (as shown in solid view) and a measured robot pose (as shown as in a faded view) having a plurality of links with joints therebetween and depicting relative axes and reference frames and their relation to one another, an end effector is shown carried by the most distal link and a 6 DoF sensor is shown to be carried by the end effector (or in a known relationship to the end effector) and a metrology measuring system, more particularly, a laser tracking measuring system, having a 6 DoF sensor carried by the end effector is utilized to determine the actual position and orientation of the end effector as it is moved toward its desired position and orientation with this FIG. 2 illustrating the transformational relationships that are used to define kinematic and measured position and orientation of the 6 DoF sensor with respect to the robot's base frame;

FIG. 3 is a graph illustrating a processed encoder and laser tracker measurements of an oscillatory trajectory used to identify the average relative time delay between actual and kinematic end effector measurements;

FIG. 4 is an exemplary illustration of the procedure used to find the leading measurement data in the lookup with timestamps that surround the delayed timestamp of the lagging measurement;

FIG. 5 is a flow chart illustrating the steps of the method of the present disclosure and describing the algorithmic procedure of the Kinematic Error Control System of the present disclosure;

FIGS. 6a and 6b are tuned responses of the corrected positional and rotational kinematic error magnitudes versus time;

FIGS. 7a-7c are, respectively, plots of the corrected kinematic error in the x (FIG. 7a), y (FIG. 7b), and z (FIG. 7c) axes of the base frame versus the distance along a lateral motion in the robot's y axis;

FIG. 8 depicts filtered corrected positional kinematic error magnitude compared to increasing end effector velocity;

FIGS. 9a-9d depict corrected positional kinematic error response of the Kinematic Error Control System due to an external force disturbance; and

FIGS. 10a-10d depict corrected rotational kinematic error response of the Kinematic Error Control System due to an external force disturbance.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing a particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts are causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

The apparatuses/systems and methods described herein can be implemented at least in part by one or more computer program products comprising one or more non-transitory, tangible, computer-readable mediums storing computer programs with instructions that may be performed by one or more processors. The computer programs may include processor executable instructions and/or instructions that may be translated or otherwise interpreted by a processor such that the processor may perform the instructions. The computer programs can also include stored data. Non-limiting examples of the non-transitory, tangible, computer readable medium are nonvolatile memory, magnetic storage, and optical storage.

As used herein, the term module can refer to, be part of, or include an application specific integrated circuit (ASIC); an electronic circuit; a combinational logic circuit; a field programmable gate array (FPGA); a processor (shared, dedicated, or group) that performs instructions included in code, including for example, execution of executable code instructions and/or interpretation/translation of uncompiled code; other suitable hardware components that provide the described functionality; or a combination of some or all of the above, such as in a system-on-chip. The term module can include memory (shared, dedicated, or group) that stores code executed by the processor.

The term code, as used herein, can include software, firmware, and/or microcode, and can refer to one or more programs, routines, functions, classes, and/or objects. The term shared, as used herein, means that some or all code from multiple modules can be executed using a single (shared) processor. In addition, some or all code from multiple modules can be stored by a single (shared) memory. The term group, as used above, means that some or all code from a single module can be executed using a group of processors. In addition, some or all code from a single module can be stored using a group of memories.

The nomenclature used in this disclosure is as follows.

Nomenclature

| | |
|---|---|
| T^{b}ᵣ | kinematic location of 6DoF sensor with respect to the robot's base frame |
| R^{b}ᵣ | rotation matrix of kinematic location of 6DoF sensor with respect to the robot's base frame |
| p^{b}ᵣ | position of kinematic location of 6DoF sensor with respect to the robot's base |
| | frame |
| T^{b}ₙ(•) | equation that converts robot measurement into homogenous transformation |
| r | robot measurement |
| Tⁿᵣ | transformation to the 6DoF sensor location with respect to robot's tool flange |
| T^{b}ₘ | measurement of 6DoF sensor with respect to the robot's base frame |
| R^{b}ₘ | rotation matrix of 6DoF sensor measurement with respect to the robot's base |
| | frame |
| P^{b}ₘ | position of 6DoF sensor measurement with respect to the robot's base frame |
| T^{b}ₗₜ | transformation of laser tracker with respect to the robot's base frame |
| T^{lt}ₘ(•) | equation that converts tracker measurement into homogenous transformation |
| | matrix |
| s | tracker measurement |
| k | control iteration |
| e | kinematic error measurement |
| eᵣ | translational component of kinematic error measurement |
| ƒᵣ(•) | rotational component of kinematic error measurement |
| ƒ_{θ}(•) | equation that converts rotation matrix into axis angle representation |
| | equation that converts rotation matrix into robot manufacturer's orientation |
| | representation |
| ê | kinematic error estimate |
| Δt | time difference between current and previous control iteration |
| L | observer gain matrix |
| Δeₚ | corrected positional kinematic error |
| Δeᵣ | corrected rotational kinematic error |
| Δp | translational incremental correction |
| Δr | rotational incremental correction in axis angle representation |
| Δθ | rotational incremental correction in manufacturer's orientation representation |
| Kₚ | translational feedback gain matrix |
| Kᵣ | rotational feedback gain matrix |
| Δ\tilde{p} | round translational incremental correction |
| Δ\tilde{θ} | round rotational incremental correction in manufacturer's orientation |
| | representation |
| ηₚ | residual of translational incremental correction |
| η_{θ} | residual of rotational incremental correction |
| Pᵤ | total translational incremental correction |
| Rᵤ | total rotational incremental correction as a rotation matrix |

In the present disclosure, the topology, theory, and operation of a control system, used to correct a robot's kinematic error, is described. The control system, referred to as the Kinematic Error Control System, is comprised of several subsystems, each containing several components, which facilitate its operation. These subsystems are a robot control system, a metrology tracking system, and an external control system on which the Kinematic Error Control System is implemented. A table showing the various components in relation to their respective subsystem and a signal diagram of the signals transmitted between the components are shown in Table 1 and FIG. 1, respectively.

TABLE 1
Components and Subsystems of Kinematic
Error Control System

| Component | Subsystem |
|---|---|
| Robot | Robot Control System |
| Robot Controller | Robot Control System |
| Laser Tracker | Metrology Tracking System |
| 6DoF Sensor | Metrology Tracking System |
| PC | External Control System |

The robot control system has two components, the robot, and the robot controller. The robot is the mechanical system that performs the physical operation. The robot contains encoders and servo motors used to both measure and move each of its joints. The robot controller contains the servo drives and the robot manufacturers proprietary trajectory controller which are used to both regulate and control the robot through a desired motion. The proprietary trajectory controller utilizes the forward kinematic model of the robot to convert the encoder (joint) measurements into a kinematic position and orientation of its tool flange for use in its control algorithm. In subsequent discussion the joint or kinematic position and orientation measurements will be referred to as robot measurements. In addition to the servo drives and trajectory controller, the robot controller contains the network interfaces used to communicate with the external control system as well as the software used to adjust its trajectory based on corrections transmitted from the external control system.

In this specific case the metrology tracking system has two components, the 6 DoF sensor and the laser tracker. The 6 DoF sensor is fixed to an end effector which is attached to the robot's tool flange. The 6 DoF sensor houses several orientation sensors and a retro reflector which are used to measure its orientation and position, respectively. More specifically the position of the 6 DoF sensor is measured by the laser tracker and the orientation of the 6 DoF sensor is measured by the sensor itself and transmitted to the tracker. The laser tracker houses a gimbaled laser displacement sensor that emits a laser beam which is reflected by the 6 DoF sensor's retro reflector back to the tracker. The azimuth and elevation of the beam, determined by the laser tracker's encoders, and the distance of the beam are used to determine the 6 DoF sensor's position. Position and orientation measurements collected by the laser tracker and 6 DoF sensor, respectively, are combined through a proprietary method to create a single measurement of the position and orientation of the 6 DoF sensor, and hence the actual position and orientation of the end effector. In subsequent discussion this measurement will be referred to as the tracker measurement. Additionally, the laser tracker contains the interface used to transmit the tracker measurements to the external controller system.

The external controller system is comprised of a computer (PC) containing the network interfaces used to receive the transmitted robot and tracker measurements from the robot controller and laser tracker, respectively. The robot controller and laser tracker may be unsynchronized, that is, measurements sampled and transmitted independently without using a shared clock signal between the robot controller and laser tracker. At runtime, the robot measurement is matched to the tracker measurement, the matched set of measurements are used to compute a kinematic error measurement, a kinematic error estimate is computed from the kinematic error measurement, and a rounded incremental correction of the end effectors position and orientation are computed from the kinematic error estimate. The incremental correction command is then transmitted to the robot controller where it is used to correct the position and orientation of the robot's end effector.

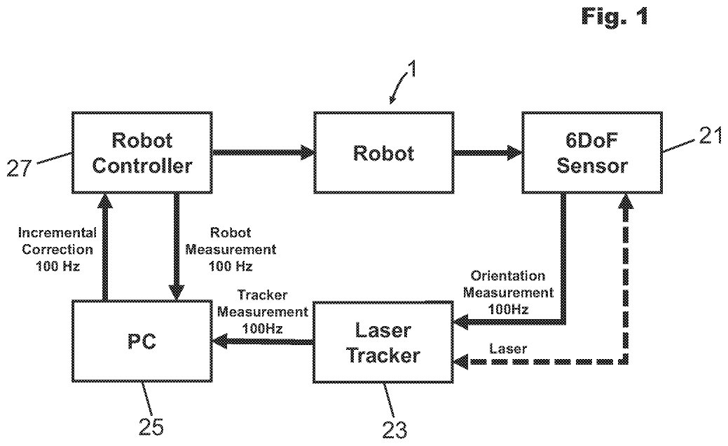

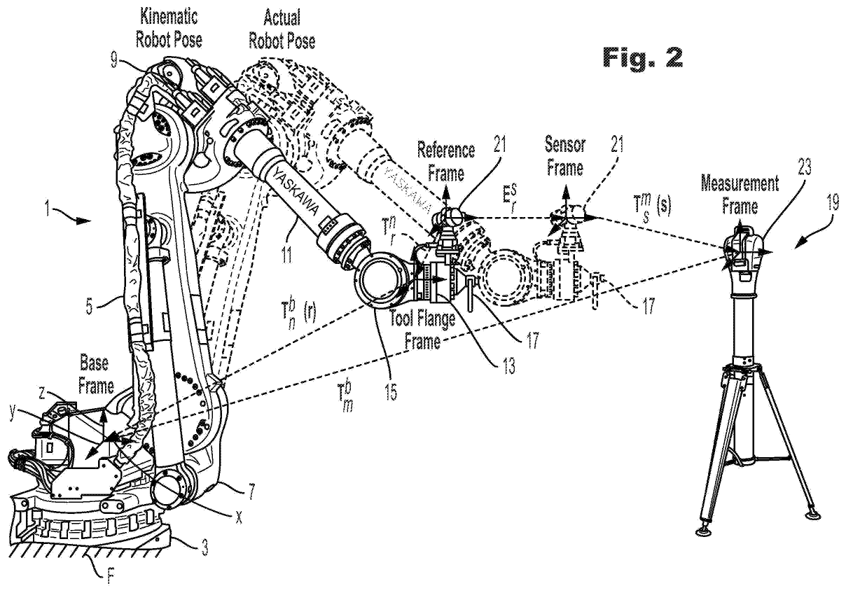

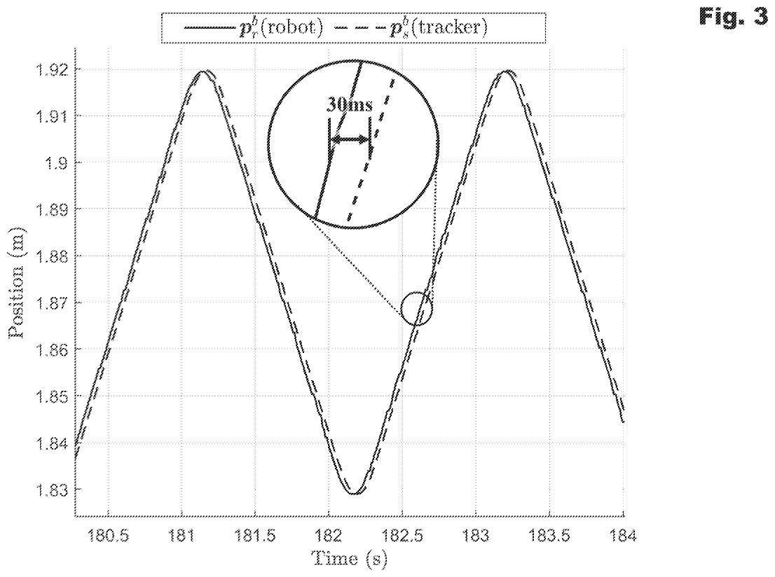

If the robot measurements are described using joint measurements, the robot and tracker measurements will be defined in different spatial domains. In this case, the robot measurements describe the position of its joints as coordinates in joint space while the tracker measurements describe the position and orientation coordinates of its tool flange in Euclidian space. These measurements must be converted into the same spatial domain to compute the kinematic error measurement. In the present disclosure, Euclidian space is used. Additionally, there are many ways to represent both the position and orientation of a 3D object in Euclidian space. In the field of robotics, it is common to represent a 3D object as a homogenous transformation matrix that defines the position and orientation of a frame with respect to another frame. The position is represented in cartesian coordinates and the orientation is represented as a rotation matrix, describing the projection of the axes of one frame with respect to the axes of another. This representation is both intuitive and provides a set of mathematical operators that can be used to determine the relative relationship of various frames. Further discussion describes how the robot and tracker measurements are converted into Euclidian space (if applicable) and represented as homogenous transformation matrices with respect to the same frame. A graphic depiction of the transformative relationships between the frames used to define the kinematic (robot) and actual (tracker) position and orientation of the 6 DoF sensor, equivalently the position and orientation of the end effector, with respect to the robot's base frame is shown in FIG. 2.

Referring now to FIG. 2 and more specifically, a typical industrial robot is indicated in its entirety at 1 and is shown in its Kinematic Robot Pose (as shown in solid view) and in its Actual Robot Pose (as shown in faded view). Specifically, the robot shown in FIG. 2 is a Yaskawa/Motoman MH180 industrial robot. However, those skilled in the art will recognize that the system and method of the present disclosure may be used with any conventional industrial robot. Robot 1 is shown to have a base 3 securely attached to the floor F. A first rigid link or column 5 extends from the base. As further shown in FIG. 2, the base frame reference has a vertical axis Z and planar coordinates X and Y that lie in a horizontal plane parallel to the floor F. Link 5 is selectively rotatable about a vertical axis Z to establish the azimuth angle for the remainder of the robot 1 by a first motorized joint 7. Joint 7 also can selectively change the angle of link 5 with respect to the base. At the upper end of link 5, a second motorized joint, as generally indicated at 9, is provided. Joint 9 is driven by a motorized angle drive, and it is configured to rotate a second link 11 through a range of angles, as is also well-known in the art. A third link (also referred to as the most-distal link), as indicated at 13, is connected to the second link 11 by a third motorized spherical joint 15 containing three motors that can selectively change the orientation of link 13. Each of the motorized joints is powered by a servo motor or the like in the manner well known to those skilled in the art. An end effector 17 is carried by the third link 13. As shown in FIG. 2, a laser metrology measuring system or device, as generally indicated at 19, is provided for determining the actual position and orientation of the effector as it moves toward its desired position and orientation. Preferably, but not necessarily, this metrology measuring device 19 is a Radian 3D Laser Tracker System commercially available from API of Rockville, Md. This laser tracker system comprises a laser sensor target, as indicated at 21, that is carried by the end effector 17. The laser tracker system also has a laser tracker, as indicated at 23, which is movably mounted on a tripod or the like so as to have a clear line of sight to the laser sensor target 21 as the sensor target moves throughout its range of motion. The sensor target 21 is, preferably, is a 6 Degree of Freedom (6 DoF) sensor and is capable of tracking the position and orientation of the laser sensor target 21 and hence the end effector 17. The laser tracker 23 emits a laser beam, which is reflected by the laser target 21 back to the laser tracker by means of a retro reflector (not shown) contained in the sensor target. The laser tracker has the capability to accurately measure the position and orientation of the laser target with respect to the laser target as it is moved by the robot toward its predetermined final or end position. In a manner well-known in the art, the location of the laser sensor target 21 may be readily and accurately related to the position and orientation of the end effector 17 or to the position and orientation of any tool or the like carried by the end effector. As will be appreciated by those skilled in the art, the number of links in robot 1 may vary and the number of corresponding motorized joints may also be varied to effect movement of the end effector from a starting position and orientation to a predetermined or desired end position and orientation.

The robot measurements are represented by a single vector, r, and are described by either a set of joint positions, r=[q₁ q₂ . . . qₙ]^{T}, for each of the robot's joints in joint space (where n denotes the last joint) or a kinematic position (xᵣ, yᵣ, zᵣ) in cartesian coordinates and orientation (αᵣ, βᵣ, γᵣ), in an orientation representation defined by the robot manufacturer, of the robot's tool flange in Euclidian space, r=[xᵣ yᵣ zᵣ αᵣ βᵣ γᵣ]^{T}. In the case that the robot measurement is described by joint positions, the robot's forward kinematic equations, from its forward kinematic model, are used to convert the robot measurement into a homogenous transformation of the frame defining its tool flange with respect to the robot's base frame. In the case that the robot measurement is described by the kinematic position and orientation of the robot's tool flange, the orientation of the robot measurement is converted into a rotation matrix to construct an equivalent homogenous transformation to the one produced by the kinematic equations. In both cases, an additional transformation that defines the translation and rotation of the 6 DoF sensor with respect to the robot's tool flange is applied in order to construct the kinematic position and orientation of the 6 DoF sensor,

$${T}_{r}^{b} = [ \begin{matrix}{R}_{r}^{b} & {p}_{r}^{b} \\ 0 & 1\end{matrix} ] = {T}_{n}^{b} ( r ) {T}_{r}^{n} \qquad ( 1 )$$

where pᵣ^{b} is the kinematic position and Rᵣ^{b} is the kinematic orientation (represented as a rotation matrix) of the 6 DoF sensor relative to a robot base frame, Tₙ^{b}(·) is the equation that converts the robot measurements, r, into a homogenous transformation, and Tᵣⁿ is the transformation to the 6 DoF sensor with respect to the robot's tool flange. The transformation Tᵣⁿ is identified using standard techniques commonly understood by those skilled in the art.

The tracker measurements are taken with respect to the laser tracker's measurement frame and represented by a single vector, s=[xₛ yₛ zₛ αₛ βₛ γₛ]^{T}, of its position (xₛ, yₛ, zₛ) and orientation (αₛ, βₛ, γₛ) in an orientation representation defined by the laser tracker manufacturer. The measurements are converted into a homogenous transformation matrix and transformed into the robot's coordinate system by,

$${T}_{s}^{b} = [ \begin{matrix}{R}_{s}^{b} & {p}_{s}^{b} \\ 0 & 1\end{matrix} ] = {T}_{m}^{b} {T}_{s}^{m} ( s ) \qquad ( 2 )$$

where pₛ^{b} is the measured (actual) position and Rₛ^{b} is the measured (actual) orientation (represented as a rotation matrix) of the 6 DoF sensor, Tₛ^{m}(·) is the equation that converts the tracker measurements, s, into a homogeneous transformation matrix, and Tₘ^{b} is the transformation of the laser tracker's measurement frame with respect to the robot's base frame.

The transformation Tₘ^{b} is identified by the using standard techniques commonly understood by those skilled in the art.

As mentioned in [0034] the robot and tracker measurements may be unsynchronized. Lack of synchronicity of the measurements will result in both a relative time delay between the two clock signals and jitter in each clock signal's timing. Each of these issues are addressed independently in the algorithmic procedure discussed below.

Before runtime, the relative time delay between the clock signals is determined by using an identification procedure, run once prior to the operation of the Kinematic Error Control System. The relative time delay identification procedure is conducted as follows:
1. Generate an oscillating motion command for the robot.
2. While the robot is in motion, record Tᵣ^{b} and Tₛ^{b} data streams and plot the recorded position in time as shown in FIG. 2.
3. Using the plot, determine whether the robot or tracker measurement is lagging, and refer to it as the lagging measurement. The other measurement (robot or tracker) is referred to as the leading measurement. Define the trigger parameter as, τ, and set its Boolean value by,

$$τ = \{ \begin{matrix}1 , & robot measurement is lagging \\ 0 , & tracker measurement is lagging\end{matrix} \qquad ( 3 )$$

4. Find the average relative delay, E(δᵣ), by measuring the average temporal offset from the plot.

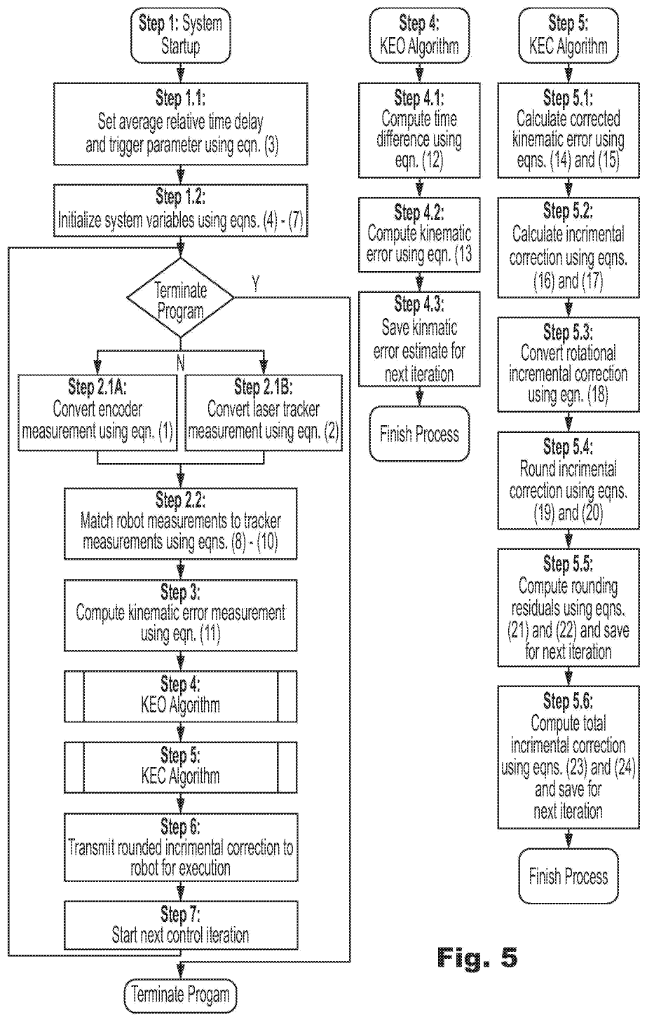

Referring to FIG. 5, this is a block diagram or flow chart of the methodology of this disclosure. The flow chart discloses the procedural steps and operation of the system and methods of this disclosure in such detail as will be understood to those skilled in the art from a review of the detailed steps shown in the flow chart with reference to the various equations described herein. The procedural steps and operation of the system are divided into six main parts, system startup (Step 1), measurement preparation and matching of the robot and tracker measurements (Step 2), computation of the kinematic error measurement (Step 3), computation of the kinematic error estimate using the Kinematic Error Observer (KEO) algorithm (Step 4), computation of the rounded incremental correction command using the Kinematic Error Controller (KEC) algorithm (Step 5), and transmission of the rounded incremental correction command via computer 25 to the robot controller 27 (Step 6).

At system startup (Step 1), the following variables, defined further in the disclosure, are initialized at the given values,

ηₚ[0]=0 (4)

η_{θ}[0]=0 (5)

pᵤ[0]=0 (6)

Rᵤ[0]=I (7)

At runtime, the robot and tracker measurements, r and s, are transmitted to the external control system independently. Once received, each measurement is given a timestamp, tᵣ and tₛ, using the clock signal of the PC, and the measurements are converted (Step 2.1.A and 2.1.B) into the same spatial domain (if applicable) and representation using Equations (1) and (2), respectively. After conversion, the leading measurements, identified by (3) from the steps in [0040] are stored in a lookup table of sufficient size (constructed using a Last in First Out (LIFO) buffer). Now, the effects of the relative time delay, discussed in [0039], are compensated by matching (Step 2.2) the robot measurements to the tracker measurements producing the set of (matched) measurements, (Tᵣ^{b}[k], Tₛ^{b}[k], tₖ[k]), for the k^{th} iteration of the Kinematic Error Control System, referred to as the control iteration, by:
1. Compute the delayed timestamp, \tilde{t}, by subtracting the average relative time delay, E(δᵣ), from the current timestamp of the lagging measurement, identified by Equation (3) from the steps in [0040], by,

$$\tilde{t} = \{ \begin{matrix}{t}_{r} - \vert E ( {δ}_{r} ) \vert & τ = 1 \\ {t}_{s} - \vert E ( {δ}_{r} ) \vert & τ = 0\end{matrix} \qquad ( 8 )$$

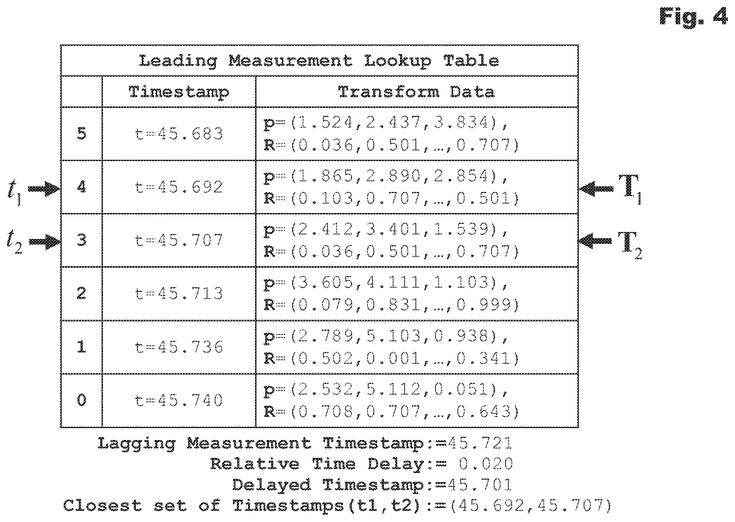

2. Compare \tilde{t} to the timestamps of the leading measurements in the lookup table until the surrounding set of timestamps, (t₁, t₂), are found such that t₁<\tilde{t}≤t₂. An example of this is shown in FIG. 4.
3. Interpolate a leading measurement, \tilde{T}, at \tilde{t} from the leading measurement data, T₁ and T₂, corresponding to the timestamps, t₁ and t₂, by,

\tilde{T}=ƒᵢₙₜ((T₁, t₁), (T₂, t₂), \tilde{t}) (9)
where ƒᵢₙₜ( . . . ):□^{4×4}→□^{4×4} is the homogenous transformation interpolation function defined in the appendix.
4. Match the lagging and interpolated leading measurements for the k^{th} control iteration by,

$$( {T}_{r}^{b} [ k ] , {T}_{s}^{b} [ k ] , {t}_{k} [ k ] ) = \{ \begin{matrix}( {T}_{r}^{b} , \tilde{T} , {t}_{r} ) & τ = 1 \\ ( \tilde{T} , {T}_{s}^{b} , {t}_{s} ) & τ = 0\end{matrix} \qquad ( 10 )$$

The kinematic error measurement, that is, the relative transformation between the matched robot and tracker measurements, is taken with respect to the robot's base frame and is computed (Step 3) by,

$$e [ k ] = [ \begin{matrix}{e}_{p} [ k ] \\ {e}_{r} [ k ]\end{matrix} ] = [ \begin{matrix}{p}_{r}^{b} [ k ] - {p}_{m}^{b} [ k ] \\ {f}_{r} ( {R}_{r}^{b} [ k ] {R}_{m}^{{b}^{T}} [ k ] )\end{matrix} ] \qquad ( 11 )$$

where eₚ and eᵣ are the translational and rotational kinematic errors and the function, ƒᵣ(·), defined in the appendix, converts the resultant rotation matrix of Rᵣ^{b}Rₘ^{b}^{^{T}} into its axis angle representation. Axis angle representation of the orientation provides an intuitive way to scale the rotation around the representation's arbitrary axis by a single scalar value.

The clock signal jitter, discussed in [0039], will corrupt the signal produced from Equation (11) with affects analogous to measurement noise (referred to as timing noise in the disclosure of our U.S. Provisional Patent Application No. 62/982,166). Compensation for jitter is accomplished by using the Kinematic Error Observer algorithm (Step 4). The algorithm is as follows:
1. Find the time difference between the current and previous control iteration,

Δt[k]=tₖ[k]−tₖ[k−1] (12)
2. Compute the kinematic error estimate,

$$\hat{e} [ k ] = \{ \begin{matrix}e [ k ] & k = 1 \\ {( I + Δ t [ k ] L )}^{- 1} ( Δ t [ k ] Le [ k ] + \hat{e} [ k - 1 ] ) & k > 1\end{matrix} \qquad ( 13 )$$

where I is an identity matrix and L is the observer gain matrix, which adjusts the amount of measurement noise that is present in the kinematic error estimate. Note that at the first control iteration, the KEO is initialized to the first kinematic error measurement.
Save the estimate computed in (16) for the next control iteration.
   The estimate computed in Equation (13) is then used in the Kinematic Error Controller (KEC) algorithm to produce and incremental correction to be sent to and executed by the robot controller.

The KEC algorithm computes a rounded incremental correction (Step 5) from the kinematic error estimate to be applied to the robot during the timestep of the control iteration. Computation of the rounded incremental correction is performed in three parts. In the first part, translational and rotational incremental corrections are computed, and the rotational incremental correction is converted into the orientation representation of the robot controller as follows:
1. Compute the corrected kinematic error by,

Δeₚ[k]=êₚ[k]−pᵤ[k−1] (14)

Δeᵣ[k]=Rᵤ[k−1]^{T} ƒᵣ⁻¹(êᵣ[k]) (15)
2. Compute the translational and rotational incremental corrections by,

Δp[k]=Kₚ(Δeₚ[k]) (16)

Δr[k]=Kᵣƒᵣ(Δeᵣ[k]) (17)
where Kₚ and Kᵣ are the translational and rotational feedback gain matrices used to adjust the convergence dynamics of the KEC, the function ƒᵣ⁻¹(·) converts the axis angle representation of the kinematic error estimate back into its equivalent rotation matrix, and pᵤ[k−1] and Rᵤ[k−1] are the total incremental corrections computed from the previous control iteration.
3. Convert the orientation representation of the incremental correction into the robot manufacturers specific orientation representation by,

Δθ[k]=ƒ_{θ}(Δr[k]) (18)
where ƒ_{θ}(·) is a function that converts the axis angle representation of an orientation into the robot controller's required orientation representation for incremental corrections. The exact form of the ƒ_{θ}(·) function is dependent on the orientation representation used by the robot controller and can be found using standard techniques commonly understood by those skilled in the art.
   The robot controller has finite resolution of its internal variables, causing a received incremental correction to be round to the controller's resolution. Consequently, correction information smaller than the resolution is lost, which results in long term degradation in the accuracy of the Kinematic Error Control System. The second part of the KEC algorithm addresses the degradation effect caused by the robot controller's resolution as follows:
4. Round the incremental correction to the resolution of the robot controller by,

Δ\tilde{p}[k]=round(Δp[k]+ηₚ[k−1], δₚ) (19)

Δ\tilde{θ}[k]=round(Δθ[k]+η_{θ}[k−1], δ_{θ}) (20)
where θₚ and θ_{θ} are the translational and rotational resolution of the robot controller, respectively, and ηₚ[k−1] and η_{θ}[k−1] are the translational and rotational rounding residuals of the previous incremental correction, respectively.
   Before completing the KEC algorithm and transmitting the rounded incremental correction to the robot controller, both the rounding residuals and total incremental correction at the current control iteration must be computed and saved for the next control iteration. Computation of these variables in the third part of the KEC algorithm is performed as follows:
5. Compute new rounding residuals for the next control iteration by,

ηₚ[k]=Δp[k]−Δ\tilde{p}[k], (21)

η_{θ}[k]=Δθ[k]−Δ\tilde{θ}[k]. (22)
6. Compute the total incremental correction for the next control iteration by,

pᵤ[k]=pᵤ[k−1]+Δ\tilde{p}[k], (23)

Rᵤ[k]=ƒ_{θ}⁻¹(Δ\tilde{θ})Rᵤ[k−1], (24)

where the function ƒ_{θ}⁻¹(·) converts the manufacturer's orientation representation back into its equivalent rotation matrix.

Once the KEC algorithm is completed, the rounded incremental corrections, Δ\tilde{p}[k] and Δ\tilde{θ}[k], are transmitted (Step 6) to the robot controller for execution, the control iteration is incremented, and the next set of matched robot and tracker measurements are used to compute a new kinematic error measurement (Step 3). Control iterations are conducted indefinitely, continually correcting the robot's kinematic error, until the program on the PC is terminated or the desired motion has completed.

An outline of the above procedure is summarized below:
1. System Startup
   1.1. Set relative time delay measured from procedure described in [0040] and trigger parameter according to Equation (3)
   1.2. Initialize System Variables using Equations (4)-(7).
2. Measurement Preparation and Matching of Robot Measurements to Tracker Measurements
   2.1.A. Convert robot measurement, r, into homogenous transformation matrix using Equation (1) and add to lookup table if determined by Equation (3) to be the leading measurement.
   2.1.B. Convert tracker measurement, s, into a homogenous transformation matrix using Equation (2) and add to lookup table if determined by Equation (3) to be the leading measurement.
   2.2. Match robot measurements to tracker measurements by comparing the timestamp of the leading measurements in the lookup table to the delayed timestamp of the lagging measurement and perform interpolation using the procedure in [0043] and Equations (8)-(10).
3. Compute kinematic error measurement using Equation (11).
4. Compute kinematic error estimate with KEO algorithm
   4.1. Compute time difference between control iterations using Equation (12).
   4.2. Compute kinematic error estimate using Equation (13).
   4.3. Save kinematic error estimate for next control iteration.
5. Compute rounded incremental path correction with KEC Algorithm
   5.1. Compute the corrected kinematic error using Equations (14) and (15).
   5.2. Calculate incremental correction using Equation (16) and (17).
   5.3. Convert rotational incremental correction to manufacturer's orientation representation using Equation (18).
   5.4. Round incremental correction using Equation (19) and (20).
   5.5. Compute rounding residuals and save for next control iteration using Equations (21) and (22).
   5.6. Compute total incremental correction and save for next iteration using Equations (23) and (24).
6. Transmit rounded incremental corrections to robot for execution.
7. Start next control iteration at step 3.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

Experimental results presented further in this disclosure were obtained using the hardware listed in Table 2.

TABLE 2
Specifications of Components in Experimental System.

| Equipment | Model | Manufacturer | Specification |
|---|---|---|---|
| Robot | MH180 | Yaskawa Motoman | 6 axes |
| | | Robotics | ± 0.2 mm |
| | | | repeatability |
| Robot Controller | DX200 | Yaskawa Motoman | δₚ = 1 μm |
| | | Robotics | δ_{θ} = 100 μdeg |
| Laser Tracker | Radian | Automated Precision Inc. | 10 μm + 5 μm/m |
| 6DoF Sensor | STS | Automated Precision Inc. | ± 2 arcsec |
| PC | Precision | Dell | Windows 10 |
| | 5820 | | Intel Xeon |
| | | | W-2125 4 GHz |

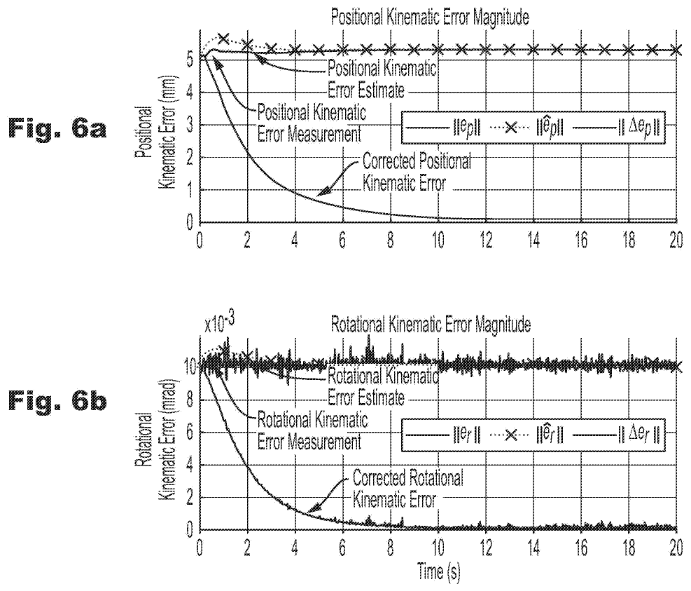

Before further evaluation of the performance of the Kinematic Error Control System could be conducted, suitable values for the KEO observer gain matrix, L, and KEC feedback gain matrices, Kₚ and Kᵣ were selected. The gain matrices were selected by commanding the robot to a single position, initializing the Kinematic Error Control System, and correcting the static kinematic errors at the commanded position. After several iterations, the final tuning of the system resulted in observer and feedback gains of L=diag(5,5,5) and K_{P}=Kᵣ=diag(5×10⁻³, 5×10⁻³, 5×10⁻³), respectively, and a stable overdamped response with a settling time of 8.758 s. FIG. 6a-6b shows the magnitude response of the corrected positional and rotational kinematic error for the tuned system.

In an additional experiment conducted for the present disclosure, the KEO algorithm's sensitivity was evaluated in both an open loop and closed loop configuration. This was done to ensure that sufficient measurement noise and jitter were filtered from the kinematic error measurement such that the residual measurement noise and jitter in the kinematic error estimate were not amplified significantly by the feedback gains in the KEC algorithm. To conduct this experiment, the robot was commanded to a single position and samples of the kinematic error estimate were measured both with (closed-loop) and without (open-loop) applying a correction with the KEC algorithm. Once the experiments were conducted, the steady state kinematic error was removed from both sets of measurements and the standard deviation was computed. The results of this experiment, provided in Table 3, show that there was an increase in the standard deviation, equivalently the noise, in the kinematic error estimate. However, when compared to the accuracy of the laser tracker in Table 2 and the process variation shown in subsequent experiments, the residual noise and jitter in the kinematic error estimate will not inhibit the Kinematic Error Control System's ability to both measure and correct the robot's kinematic error.

TABLE 3
Standard Deviation of Spatial Estimated Kinematic Error Measurement
in Open and Closed Loop System Configurations.

| | X (μm) | Y (μm) | Z (μm) | Rₓ (μrad) | R_{y} (μrad) | R_{z} (μrad) |
|---|---|---|---|---|---|---|
| Open- | 1.8 | 2 | 1.8 | 107.9 | 117.1 | 36.1 |
| Loop | | | | | | |
| Closed- | 1.8 | 2.2 | 2.2 | 119.8 | 130 | 39.6 |
| Loop | | | | | | |

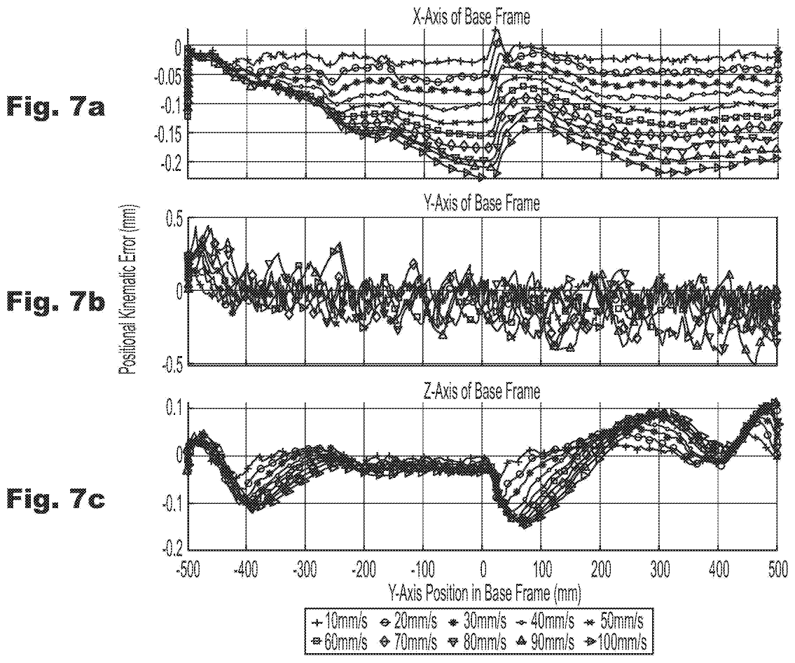

In an additional experiment conducted for this disclosure, the dynamic performance of the Kinematic Error Control System was evaluated for a series of linear, constant velocity motions of the end effector. The static kinematic error in the robot's nominal forward kinematic model is dependent on the position of its joints; therefore, increasing the commanded velocity of the industrial robot's end effector will increase the rate of change of the kinematic error that the Kinematic Error Control System will attempt to correct. In this series of experiments the robot's end effector traversed 1 m in the Y-axis of the robot's base frame at constant velocities ranging from 10 mm/s to 100 mm/s. Since the evaluated constant velocities were only performed in the Y-axis of the robot's base frame, only the corrected positional kinematic errors were evaluated in these experiments. The results of these experiments are shown in FIGS. 7a-7c.

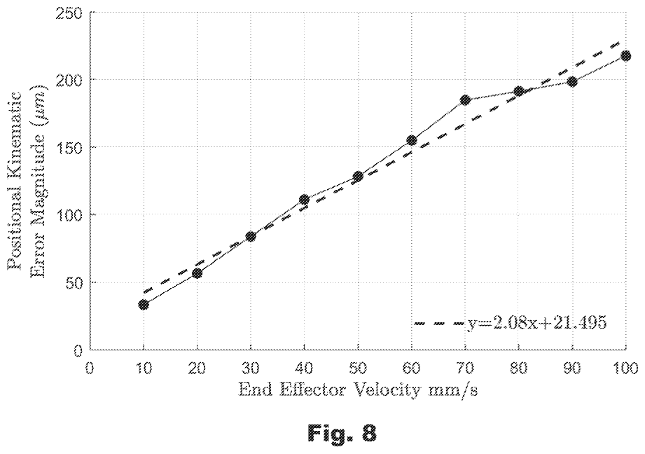

To provide a single metric for each increase in the robot's corrected kinematic error, the spatial components of the corrected positional kinematic error were filtered independently using a zero-phase 6th order Butterworth filter with cutoff frequencies ranging between 0.1 Hz and 0.5 Hz. These aggressive cutoff frequencies were selected to capture the general trends of the corrected positional kinematic errors, especially those in the Y-axis which were heavily corrupted by noise and not as easily observed. Once each component of the corrected positional kinematic error was filtered, the resultant magnitude was computed, and its average was taken. This procedure was repeated for each constant velocity experiment. The average magnitude of the filtered corrected positional kinematic errors as functions of end effector velocity are shown in FIG. 8. The increase in the corrected kinematic error magnitudes show that the performance of the Kinematic Error Control System degrades proportionally to the end effectors velocity by an increase of 20 μm of kinematic error per 1 mm/s of end effector velocity. However, all corrected kinematic errors were below the repeatability range of the robot listed in Table 1, signifying that the Kinematic Error Control System can correct the robot's kinematic errors below the robot's repeatability.

Process forces acting on the robot's end effector will cause highly nonlinear deflections, referred to as external disturbances, of the arm due to the varying stiffness of the robot's structure. More importantly, these external disturbances are due to the deformation of the robot's links and are unobservable by the robot's control system (which can only measure deviations in its joints). Thus, these external disturbances can only be corrected by the Kinematic Error Control System.

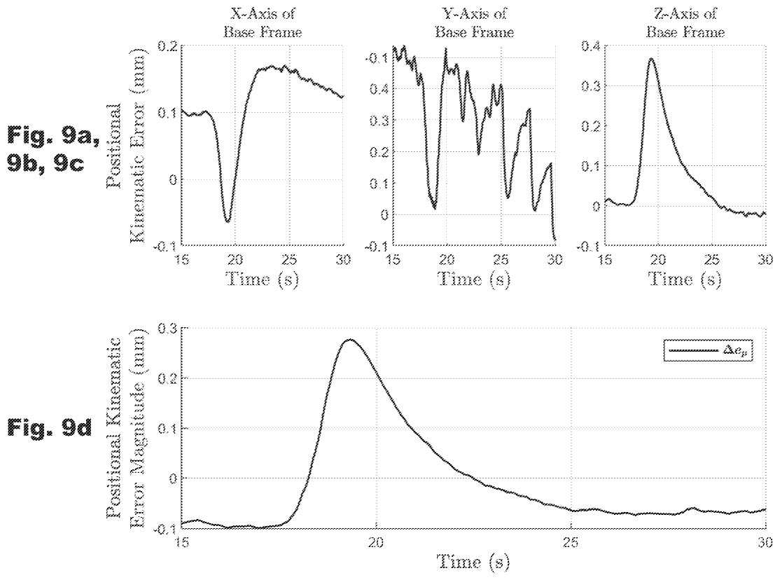

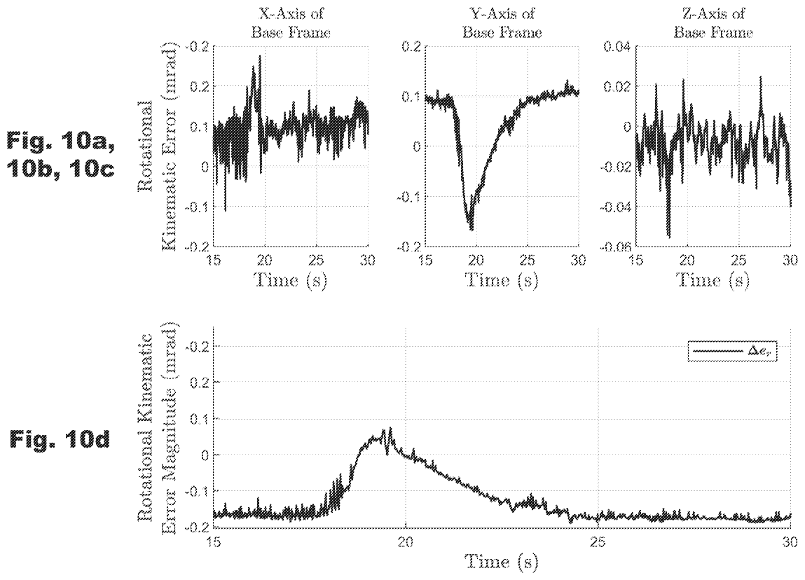

An additional experiment was conducted for the present disclosure, to evaluate the performance of the Kinematic Error Control System when subjected to an external disturbance. In this experiment the robot was commanded to a single position, the Kinematic Error Control System was initialized, and the static kinematic errors at the commanded position were corrected. Once the static kinematic errors were corrected, a 45 lb. weight was applied to the end effector to emulate a single un-modeled process force acting on the end effector. The corrected positional and rotational kinematic error responses, respectively, of the described experiment are shown in FIGS. 9 and 10. In these figures the responses were plotted over the time range where the external disturbance was observed. From the results presented in the figures it is shown that the maximum kinematic error from the external disturbance, as observed in the magnitude plots, was 374 μm and 575 mrad, respectively. The magnitudes of the corrected positional and rotational kinematic errors converge after approximately 10 s. After the responses converge, the corrected positional and rotational kinematic error magnitudes were kept below 55 μm and 100 mrad for the remainder of the experiment, nearly an order of magnitude below the range of the manufacturers specified robot repeatability of ±200 μm. Therefore, the Kinematic Error Control System achieves a higher level of performance than the robot's specifications.

### Additional Disclosure Regarding the Interpolation of a Homogenous Transformation Matrix

The function, ƒᵢₙₜ( . . . ):□^{4×4}→□^{4×4}, that produces an interpolation of a homogenous transformation between two sets of homogeneous transformations and corresponding timestamps, (T₁, t₁) and (T₂, t₂), at a specified timestamp, \tilde{t}, is defined as,

$$\tilde{T} = [ \begin{matrix}\tilde{R} & \tilde{p} \\ 0 & 1\end{matrix} ] = {f}_{int} ( ( {T}_{1} , {t}_{1} ) , ( {T}_{2} , {t}_{2} ) , \tilde{t} ) \qquad ( 25 )$$

where the interpolation of the rotation matrix, \tilde{R}, and position vector, \tilde{p}, are respectively defined as,

$$\tilde{R} = {R}_{1} {f}_{r}^{- 1} ( {f}_{r} ( {R}_{1}^{T} {R}_{2} ) ( \frac{\tilde{t} - {t}_{1}}{{t}_{2} - {t}_{1}} ) ) \qquad ( 26 )$$

$$\tilde{p} = {p}_{1} + ( {p}_{2} - {p}_{1} ) ( \frac{\tilde{t} - {t}_{1}}{{t}_{2} - {t}_{1}} ) \qquad ( 27 )$$

### Additional Disclosure Regarding the Axis Angle Representation of a Rotation Matrix

The axis-angle representation of a rotation matrix provides a more intuitive way to visualize and scale an orientation in Euclidian space. Essentially, this representation describes any orientation by a single vector which defines a single rotation about an arbitrary axis in □³. The elements of the resultant vector define the coordinates of the arbitrary axis while the vectors magnitude defines the rotation about this axis. Consider a generalized rotation matrix,

$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] . \qquad ( 28 )$$

The single rotation about the arbitrary axis is calculated from Equation (28) by,

$$θ = {cos}^{- 1} ( \frac{{r}_{11} + {r}_{22} + {r}_{33} - 1}{2} ) , \qquad ( 29 )$$

and the arbitrary axis is calculated from Equations (28) and (29) by,

$$k = \frac{1}{2 sin θ} [ \begin{matrix}{r}_{32} - {r}_{23} \\ {r}_{13} - {r}_{31} \\ {r}_{21} - {r}_{12}\end{matrix} ] = [ \begin{matrix}{k}_{x} \\ {k}_{y} \\ {k}_{z}\end{matrix} ] . \qquad ( 30 )$$

Together, Equations (29) and (30) can be combined into a single vector,

$$r = [ \begin{matrix}θ {k}_{x} \\ θ {k}_{y} \\ θ {k}_{z}\end{matrix} ] , \qquad ( 31 )$$

which is the axis angle representation, r, of a generalized rotation matrix, R

1.-14. (canceled)

15. Apparatus for controlling an industrial robot, the latter having an immovable base, a plurality of links supported by the base, a movable joint between the base and a most proximate link and between each of the adjacent links, one of the links constituting a most distal link with respect to the base, an end effector carried by the most distal link, each of the joints generating a robot measurement signal corresponding to the position and orientation of the end effector as the end effector is moved by the robot to a desired position and orientation, the industrial robot having a robot control system for controlling movement of the end effector to its the desired position and orientation, wherein said apparatus comprises:
a. a metrology tracking system for determining an actual position and orientation of the end effector as it moves toward its the desired position and orientation;
b. the metrology tracking system having a tracker and a sensor, the sensor being carried by the end effector for communicating with the tracker;
c. the metrology tracking system generating a tracker measurement signal corresponding to the actual position and orientation of the end effector as the end effector moves toward its the desired position and orientation and supplying the tracker measurement signal to a computer;
d. the computer being configured to receive the robot measurement signal from the robot control system, the robot measurement signal corresponding to the position and orientation of the end effector as determined by the robot control system; and
e. the computer being further configured to generate a correction command and to communicate the correction command to the robot control system for correcting the position and orientation of the end effector to better match the actual position and orientation of the end effector as determined by the tracker measurement signal as the end effector moves toward its the desired position thereby to result in a more accurate positioning and orienting of the end effector when in its the desired position and orientation.

16. The apparatus as set forth in claim 15 wherein the metrology tracking system comprises a laser tracker having a six degree of freedom laser sensor target carried by the end effector, the tracker being a laser tracker having a laser configured to emit a laser signal to the laser sensor target, the latter having a retro reflector therewithin for reflecting the laser signal back to the laser tracker thereby to establish a position and orientation of the end effector as the latter is moved toward its the desired position and orientation.

17. The apparatus as set forth in claim 16 wherein the tracker measurement signal is a laser tracker measurement signal that is communicated to the computer.

18. The apparatus as set forth in claim 17 wherein the computer receives a robot measurement signal, as determined by the robot control system, to construct a kinematic end effector position and orientation measurement signal, the computer being configured to utilize the laser tracker measurement signal to construct an actual end effector position and orientation measurement signal and to generate the correction command which is transmitted to the robot control system whereby the correction command is employed by the robot control system such that the kinematic end effector position and orientation, as determined by the robot control system, is corrected to better agree with the actual position and orientation of the end effector as determined by the laser tracker.

19. A method of controlling an industrial robot, the latter having an immovable base, a plurality of links, a first movable joint between the base and a most proximate link and other movable joints between each of the adjacent links, one of the links constituting a most distal link with respect to the base, an end effector carried by the most distal ink, each of the joints generating a robot measurement signal corresponding to the position and orientation of the end effector as the end effector is moved by the robot to a desired position and orientation, the industrial robot having a robot control system for controlling movement of the end effector to its the desired position and orientation, said method comprising the steps of:
f. utilizing a metrology tracking system to determine the actual position and orientation of the end effector as the latter is moved toward its the desired position and orientation;
g. utilizing the metrology tracking system to generate a tracker measurement signal corresponding to the actual position and orientation of the end effector as the latter is moved toward its the desired position;
h. supplying the tracker measurement signal to a computer; and
i. the computer receiving a robot measurement signal as determined by the robot control system, the computer constructing an end effector kinematic position and orientation signal using the robot measurement signal, and comparing the tracker measurement signal and the end effector kinematic position and orientation signal and generating an incremental correction command in response to the difference between the tracker measurement signal and the kinematic position and orientation signal with the command being transmitted to the robot control system, whereby the robot control system corrects the end effector location so as to better agree with the measurement signal.

20. The method of claim 19 wherein the metrology tracking system is a laser tracker system having a six degree of freedom laser sensor target carried by the end effector and a laser tracker, and wherein the method includes emitting a laser beam from the laser tracker which is reflected back to the laser tracker to determine the actual position and orientation of the end effector.

21. The method of claim 20 further comprises the step of the laser tracker generating a tracker measurement signal and transmitting the tracker measurement signal to the computer.

22. The method of claim 19 wherein the step of the computer constructing the kinematic position and orientation signal of the end effector further comprises matching the robot measurement signal to the tracker measurement signal, computing a kinematic error measurement, computing the kinematic error estimate using a Kinematic Error Observer (KEO) algorithm, and computing a rounded incremental correction using the Kinematic Error Controller (KEC) algorithm.

23. The method of claim 19 wherein the robot controller has a robot clock and the laser tracker has a laser tracker clock, each of the clocks generating a respective clock signal, the method further comprising identifying an average relative time delay between the robot controller clock signal and a laser tracker clock signal.

24. The method of claim 19 further compromising matching the robot measurement signal to tracker measurement signal using a lookup table to correct the average relative time delay therebetween.

25. The method of claim 22 wherein the step of computing the kinematic error measurement is determined by a relative transformation between a matched set of robot and tracker measurements and is computed by Equation Error! Reference source not found.

26. The method of claim 22 wherein the step of computing the kinematic error estimate comprises using the Kinematic Error Observer (KEO) algorithm and the Equations Error! Reference source not found. and Error! Reference source not found.

27. The method of claim 22 further comprising the steps of computing the rounded incremental correction using the Kinematic Error Controller (KEC) algorithm using Equations Error! Reference source not found—Error! Reference source not found. to compute the incremental correction.

28. The method of claim 27 further comprising modifying the incremental correction to create the rounded incremental correction to account for resolution of the robot controller using Equations Error! Reference source not found.—Error! Reference source not found.
